(19) United States
(12) Patent Application Publication
(10) Pub. No.: US 2006/0123676 A1
(43) Pub. Date: Jun. 15, 2006

(54) 3-D decorative embellishment and panel

(76) Inventor: Amy Cohen, New York, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/009,158

(22) Filed: Dec. 10, 2004

(51) Int. Cl. G09F 1/00

(52) U.S. Cl. 40/124.06

(57) ABSTRACT

A 3-D embellishment for scrapbooks and other novelty items is disclosed. The embellishment is attached to a decorative panel made of a base and a top sheet. The top sheet is made with at least one cutout. An insert formed of transparent plastic is disposed in the cutout and forms a chamber with the base. One or more objects are disposed in the chamber. The panel can be incorporated into various stationery or novelty items.

### BACKGROUND OF THE INVENTION

1. Field of Invention

This invention pertains to a decorative panel that includes a 3-D embellishment formed of a transparent insert or membrane holding small colorful objects. The membrane can have a regular geometric shape or can have a free-flowing shape. Preferably, the membrane is captured between two flat members, at least one of which has a cutout complementary to the shape of the membrane.

2. Description of the Prior Art

A scrapbook is used to store a collection of memorabilia and similar objects. Typically, the scrapbook is used to hold these articles in an aesthetic and attractive manner so that it can be displayed and shown to various people. For this reason, typically, scrapbook consists of several pages, the pages being used for or associated with a unique collection of items such as photographs, paper crafts and journaling. Moreover, several pages can be grouped together based on a common theme. For instance, a group of scrapbook pages having a “Holiday” theme would comprise photographs taken during that holiday and paper crafts depicting the holiday, as well sketches, cutouts and other items associated with the theme. In addition, the scrapbook page may be used to record information about the holiday, and other journaling information.

A purpose of making a scrapbook as opposed to simply putting pictures in a photo album is to create a unique, personalized memento that could become a family heirloom that will be cherished for a lifetime, and perhaps passed on to the next generation. The task of creating a personalized scrapbook provides benefit to those participating in this craft as well as the recipient of the completed scrapbook.

The scrapbook business has grown over the past several years. Today there are scrapbook specialty stores, magazines devoted to the craft, and a plurality of websites offering on-line merchandise sales and creative tips. The type of merchandise available in this market segment has grown substantially. Today, a person can purchase scrapbook specialty items including scissors to cut a variety of patterns, pre-printed patterned paper and paper in all colors of the rainbow, rubber stamps, stickers, templates, stencils, die cuts, specialty pens and markers, specialty adhesives, and die punches.

In addition, many novelty items and other articles targeted for use by infants and children frequently include colorful elements. Typically, these elements, that may include threads, beads, material cut-outs, tapes, ribbons, etc., are secured to a flat member, such as cardboard. Generally, the securing means may include sewing thread, an adhesive, and other similar means. However, the type and size of these elements is very limited.

### SUMMARY OF THE INVENTION

In accordance with this invention, a panel is formed of two flat members made of sheet-like materials such as paper or cardboard. One of the members forms a base and the second member forms a top sheet. The top sheet is made with a cutout having a predetermined shape and size.

An embellishment is provided that includes a transparent insert is also provided for the panel that has a flat top surface, a peripheral sidewall attached to the top surface and an extension dependent from the sidewall and extending outwardly. The insert is introduced into the cutout with the extension being captured between the base and the top sheet. One or more small articles, such as beads, are inserted into a chamber formed between the insert and the base.

The panel is then either affixed to a scrapbook page or is attached to a scrapbook page.

In one embodiment, the elements required to make the embellishment are distributed as a kit. The kit is purchased and used to make embellishments and attach them to scrapbooks or other items. Optionally, the kit includes a die or a piece of cardboard for making the cutout and instructions for making the embellishment.

### BRIEF DESCRIPTION OF THE FIGURE

FIG. 1 shows a plan view of a decorative panel constructed in accordance with this invention;

FIG. 2 shows an enlarged partial sectional view of the panel of FIG. 1;

FIG. 3 shows a plan view of die that may be inserted into a kit for making the embellishment;

FIG. 4 shows a plan view of the top sheet without the cutout;

FIG. 5 shows the die of FIG. 3 used to form the insert;

FIG. 6 shows a free form insert shaped like a glass.

### DETAILED DESCRIPTION OF THE INVENTION

Referring to the Figures, a decorative panel 10 constructed in accordance with this invention includes a base 12 and a top sheet 14. Both of these members may be made of a flat material, such as cardboard, paper or other similar material and they may have the same or different thicknesses and color. The top sheet 14 is formed with one or more cutouts. The embodiment shown in the Figures has two cutouts 16A and 16B. The cutouts may have a regular geometric shape such as a circle, a square, a rectangle, a heart, a star etc. or they can have a free or irregular form. The cutouts (and matching inserts) can also be in the shapes of letters, numbers, flowers, animals, etc.

The panel 10 further includes two transparent inserts 18A, 18B.

Both inserts 18A, 18B are formed with a top surface 20 that is preferably flat, a sidewall 22 and an extension 24 disposed in parallel to the top surface and disposed outwardly of the sidewall 22. The inserts are sized and shaped so that their sidewalls 22 and top surfaces 20 are complementary to and fit through the cutout 16A, 16B, respectively, as seen in FIG. 2.

The base 12 and the top sheet 14 are preferably secured to each other with an adhesive so as to trap the extensions of the inserts 18A, 18B. In this manner, the inserts 18A, 18B and respective portions of the base 12 define respective chambers 26A, 26B. These chambers are used to hold small decorative objects 28. Objects 28 preferably have different colors, sizes and shapes. These objects may be, for example, beads, confetti, charms, memorabilia, and so on. Different objects 28 may be used for different panels.

The inserts 18A, 18B, may be made of any suitable material that is relatively stiff to protect the integrity of chambers 26A, 26B and protect the objects contained therein. For example, the inserts can be molded from a thin clear plastic material

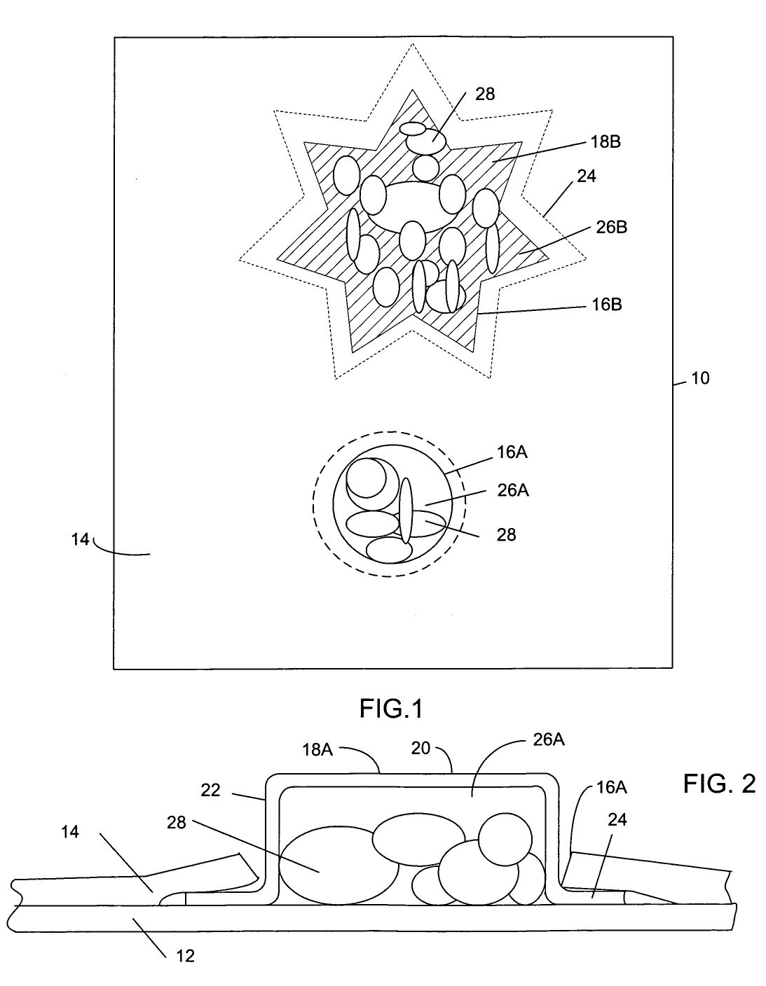

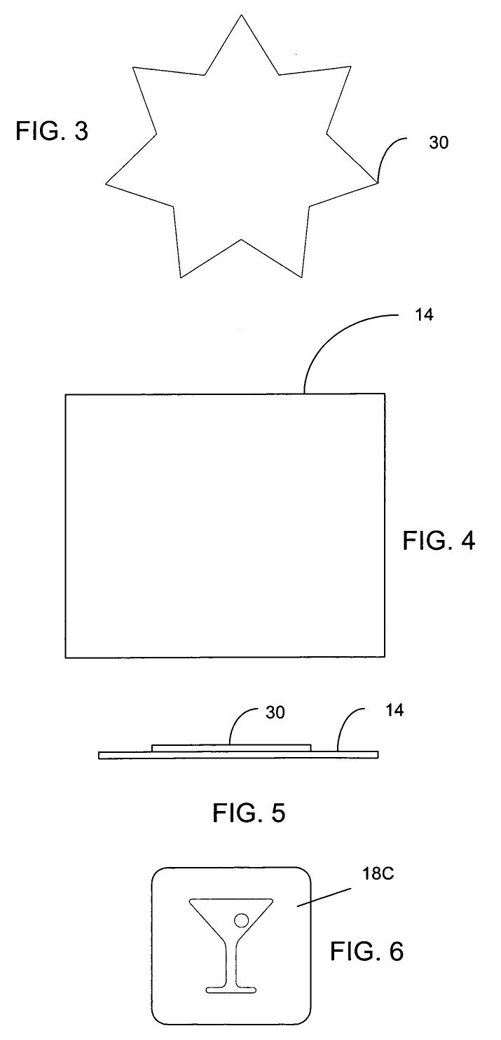

As discussed above, the base 12 and the top sheet 14 can have the same color. Alternatively, the base can have a different color so that it shows up clearly and provide a pleasing aesthetic view, as indicated in FIG. 1 for chamber 26B.

The panel 10 is made and formed as follows. First, the base 12 and top sheet 14 are cut to size. Then the cutouts 16A, 16B are made in the top sheet 14 using dies matching the shape of the inserts, and the inserts 18A, 18B are formed by a well known method, such as molding.

The inserts 18A, 18B are placed into the cutout, the objects 28 are placed on the inserts, and the base 12 and the top sheet 14 are then secured to each other thereby engaging and trapping the extensions 24 of the inserts. Each insert and corresponding objects thus forms a respective 3-D embellishment.

The panel 10 can be made big enough so that it forms a scrapbook page. Alternatively, the panel 10 can also be attached to or otherwise incorporated into scrapbook pages. In addition, the panel can also be incorporated in various types of stationary, novelty items, greeting cards, and so on. The size, number and shape of the inserts is determined and selected based on the respective stationery or novelty item.

The inserts can be mass-produced for various articles. Alternatively, the inserts can be designed to hold particular objects. For example, an infant picture album may be assembled using as the decorative object in the insert an article associated with a particular infant, such as a tooth, a lock of hair, etc.

In one embodiment of the invention, the 3-D embellishments can be made sold or distributed as kits. Each then includes at least one insert having a specific size and shape, and a plurality of objects of different sizes, shapes and colors and designed so that at least some of the objects can be fitted in the insert and form the 3-D embellishment.

Optionally, the kit includes a die matching the size and shape of the insert. For example, the kit could include a die 30 having the size and shape of the insert 18B. The die could be made of a paper, metal or plastic material, however, preferably, it is piece of cardboard that is relatively cheap and light. Optionally, the kit includes two blank pieces of paper or cardboard to form the base and top sheet, respectively.

A customer can then buy the kit and use it to make and incorporate the 3-D embellishment into a scrapbook. As part of this process, the customer uses the die 30 first to make the cutout 16A, as shown in FIG. 5. For this purpose, the die 30 is placed over top sheet 14. A pencil or other instrument is used to trace the outline of the die on the top sheet 14. Alternatively, the top sheet 14 is scored. Next, a knife or other instrument is used to make the cutout 16A in the sheet 14.

As discussed above, the insert and the corresponding cutout may have a free form shape instead of a regular geometric shape. This free form shape may be an arbitrary abstract shape, or the shape of a known article. For example, in FIG. 6 an insert 18C is shown having the shape of a glass.

Obviously, numerous modifications may be made to the invention without departing from its scope, as defined in the appended claims.

I claim:

1. A decorative panel comprising:
a base;
a top sheet adhesively attached to the base and having at least a cutout of predetermined shape;
a 3-D embellishment formed of an insert having said predetermined shape and disposed in said cutout, said insert having a peripheral extension trapped between said base and said top sheet to define a chamber with said base; and
an object disposed in said chamber.

2. The panel of claim 1 wherein said insert has a flat surface and a sidewall surrounding said flat surface, with said extension surrounding and depending from said sidewall.

3. The panel of claim 2 wherein said top surface is relatively flat and extends in parallel with said base.

4. The panel of claim 1 wherein said cutout has a geometric shape.

5. The panel of claim 1 wherein said cutout and said insert have complementary shapes.

6. A decorative panel comprising:
a base made of a sheet-type material;
a top sheet adhesively attached to said base and also made of a sheet-type material and having a cutout of predetermined size and shape;
a 3-D embellishment including an insert having a shape complementary to said cutout out and an extension extending outwardly, said insert being disposed in said cutout with its extension being trapped between said base and said top sheet; and
a plurality of decorative objects disposed in said insert.

7. The panel of claim 6 wherein said insert is made of a transparent material.

8. The panel of claim 6 wherein said insert is molded from a transparent plastic material.

9. The panel of claim 6 wherein said panel is sized and shaped to be incorporated into a book.

10. A novelty item incorporating the decorative cover of claim 6.

11. The novelty item of claim 10 wherein said novelty item is loose leaf cover.

12. A kit for a 3-D embellishment for a scrapbook or other novelty item, said kit comprising:
an insert having a relatively flat surface and an extension offset from said flat surface to define cavity; and
a plurality of decorative objects for said cavity.

13. The kit of claim 12 further comprising a die for making a cutout in a top sheet for the insert, said die having a shape corresponding to the shape of said insert.

14. The kit of claim 12 wherein said insert has a geometric shape selected from the group consisting of a circle, a square, a rectangle and a star.

15. The kit of claim 12 wherein said insert has a free form.

16. The kit of claim 12 wherein said insert has a predetermined shape.

17. The kit of claim 12 further comprising two sheets, said 3-D embellishment including a base formed of one of said sheet, and a top sheet formed of said other sheet.

18. The kit of claim 12 wherein said insert is transparent.
